(19) United States
(12) Patent Application Publication
(10) Pub. No.: US 2011/0260413 A1
(43) Pub. Date: Oct. 27, 2011

(54) SINGLE PIECE GASKET

(75) Inventors: Robert R. Voltenburg, Davison, MI (US); Loren M. Thompson, Lapeer, MI (US)

(73) Assignee: CURLIN MEDICAL INC., East Aurora, NY (US)

(21) Appl. No.: 13/127,515

(22) PCT Filed: Oct. 22, 2009
(86) PCT No.: PCT/US09/61583

§ 371 Date: Jul. 13, 2011

Related U.S. Application Data
(60) Provisional application No. 61/198,848, filed on Nov. 10, 2008.

(51) Int. Cl. F16J 15/10; F16J 15/06

(52) U.S. Cl. 277/644; 277/628

(57) ABSTRACT

A single piece gasket is provided wherein the single piece gasket includes a gasket member first portion and a gasket member second portion integral to the gasket member first portion. The gasket member first and second portions are in a common plane when the gasket member is in a relaxed state, and the first and second portions are in intersecting planes in a flexed state. The gasket member first portion is operatively configured to seal at least two compartments. The first and gasket member second portions have substantially circular cross-sections.

### CROSS REFERENCE TO RELATED APPLICATION

This application claims the benefit of U.S. Provisional Patent Application Ser. No. 61/198,848 for a SINGLE PIECE GASKET, filed on Nov. 10, 2008, which is hereby incorporated by reference in its entirety. This claim is made under 35 U.S.C. §119(e); 37 C.F.R. §1.78; and 65 Fed. Reg. 50093.

### TECHNICAL FIELD OF INVENTION

The present disclosure relates generally to a single piece gasket for sealing multiple components, in which the mating surfaces of the components extend in non-parallel intersecting planes.

### BACKGROUND OF INVENTION

As is traditionally known in the art, a gasket is a mechanical seal that fills the space between the mating surfaces of two objects to prevent leakage between an interior compartment defined by the two objects and the exterior environment. Gaskets are an integral component of any device which requires confinement of a gas or liquid. Gaskets compensate for the unconformity of mating surfaces. These surface irregularities may be minute or large, depending on the purpose of the device but in all cases, the gasket is use to compensate for the difference while inhibiting the flow of fluids in either direction between the parts. Gaskets may reduce manufacturing costs by allowing less precise mating surfaces to be formed on machine parts.

A gasket is generally viewed as a material or combination of materials clamped between two mating surfaces of a mechanical joint. Its function is to create a seal between the mating surfaces and maintain the seal for a prolonged period. The gasket is generally capable of hermetically sealing the mating surfaces, impervious and resistant to the medium being sealed, and able to withstand the application temperature and pressure. Generally, gaskets are made from a material that is to some degree yielding such that it is able to deform and tightly fill the space it is designed for, including, as previously mentioned, any slight irregularities.

Important gasket material properties for effective sealing performance include: chemical compatibility, heat resistance, compressibility, recovery, creep relaxation, erosion resistance, compressive strength, tensile strength, shear strength, and dimensional stability. Gaskets are commonly produced by cutting from sheet materials, such as gasket paper, rubber, silicone, metal, cork, felt, neoprene, nitrile rubber, fiberglass, or a plastic polymer (such as polychlorotrifluoroethylene). Most non-metallic gaskets comprises of a fibrous base held together or strengthened with an elastomeric binder. The combination of the binders and base chosen depends, at least in part, on the compatibility with components and the conditions of the sealing environment as well as the load bearing characteristics required for the application.

With respect to commonly used sheet or planar gaskets, the premise is simple in that traditionally a sheet of planar material (generally a fibrous material) has the gasket shape “punched out” of it. A planar gasket may also be manufactured by injection molding. These gaskets can fill many chemical requirements based on the inertness of the material used and can fit many budgetary restraints. These sheet or planar gaskets are simple and cost effective to manufacture; however, these substantially planar gaskets are effective only on mating surfaces that extend in a common plane.

To seal multiple components having mating surfaces on non-parallel intersecting planes would require multiple sheet gaskets or a gasket that extends in three dimensions. The cost to manufacture a three dimensional gasket is substantially greater than that of a planar gasket due to the complexity of the processes and specialty tools required. For example, to injection mold a three dimensional gasket, multiple cams and slides would need to be used to mold the desired three dimensional shape. Furthermore, it would require complex parts removal robots and methodology to remove the three dimensional gasket from the molds in order too maintain the gasket desired geometry.

What is desired is a single piece gasket that can be manufactured in a planar mold and capable of sealing components, in which the mating surfaces of the components extend in multiple non-parallel intersecting planes.

### SUMMARY OF THE INVENTION

A single piece gasket is disclosed herein. The single piece gasket includes a single continuous gasket member being operatively configured to seal at least two components. The single piece gasket member includes a gasket member first portion that cooperates with a gasket member second portion to define a first perimeter and a second perimeter. The first perimeter extends in one plane and the second perimeter extends in a non-parallel intersecting plane, when the gasket is in a flexed or rotated state. The gasket member first portion is formed integrally with the gasket member second portion. The first and second portions of the gasket member have substantially circular cross-sections and formed of silicone.

### BRIEF DESCRIPTION OF THE DRAWINGS

Features and advantages of embodiment(s) of the present disclosure will become apparent by reference to the following detailed description and drawings, in which like reference numerals correspond to similar components. Reference numerals having a previously described function may or may not be described in connection with other drawings in which they appear.

FIG. 1 is a front view of one embodiment of a single piece gasket in its newly formed state (in a single plane);

FIG. 1A is a side view of the single piece gasket of FIG. 1;

FIG. 2 is a perspective view of the single piece gasket of FIG. 1, with a gasket member second portion rotated 90° relative to the gasket member first portion such that the gasket is implemented in two intersecting planes;

FIG. 2A is a side view of the single piece gasket of FIG. 1, with the gasket member second portion rotated 90° relative to the gasket member first portion.

FIG. 3 is a cross-sectional view of an embodiment of the single piece gasket of FIG. 1 taken along lines 3-3 of FIG. 2; and

FIG. 4 is a semi-schematic illustration which shows an embodiment of the single piece gasket of FIG. 1 mounted on exemplary components having mating surfaces that are on non-parallel intersecting planes.

### DETAIL DESCRIPTION OF INVENTION

The embodiment disclosed herein is single piece gaskets for use in an assembly where multiple components are integrally assembled in which the components' mating surfaces extend along non-parallel intersecting planes. For example, shown in FIG. 4, is an infusion pump assembly 30 having a housing 16 and a pumping mechanism 18. The mating surfaces of the pumping mechanism 18 extend on a plane substantially perpendicular to the plane on which the mating surfaces of the housing 16 are positioned.

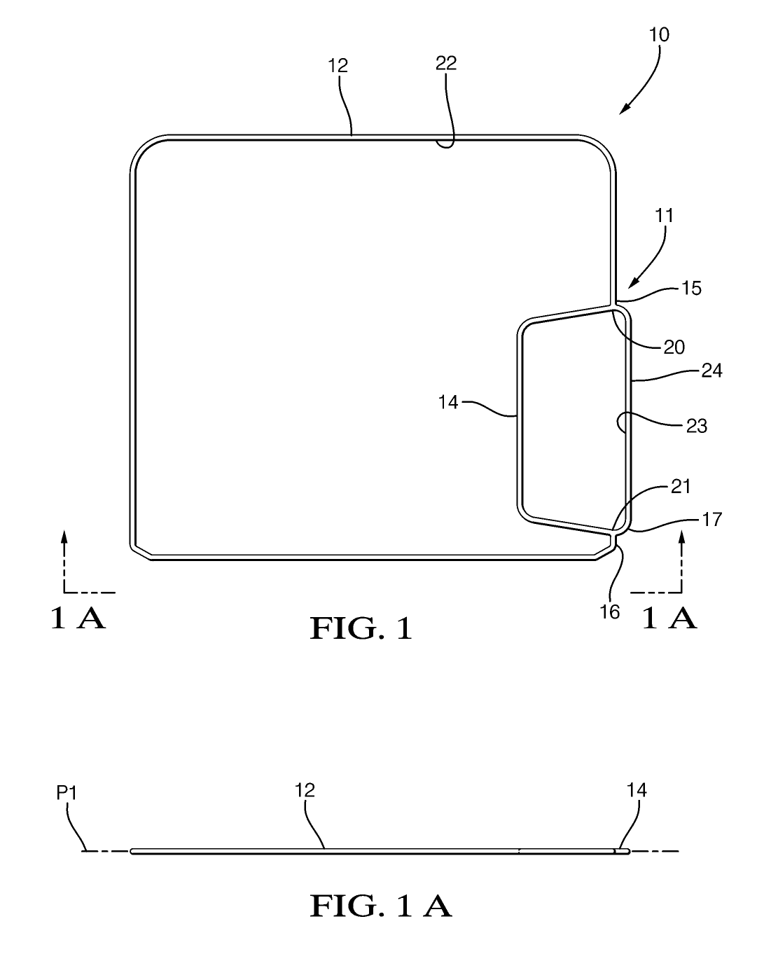

Shown in FIGS. 1 through 3 is a single piece gasket 10 having a single continuous gasket member 11. The single continuous gasket member 11 includes a gasket member first portion 12 and a gasket member second portion 14. The gasket member second portion 14 defines a closed second perimeter 23 having an exterior side 17. The closed second perimeter 23 may be that of any shape adapted to secure and seal the mating surfaces of a predetermined component. For exemplary purposes, a pumping mechanism 18 is shown in FIG. 4 having a substantially rectangular mating surface.

The gasket member first portion 12 includes a first end 15 and a second end 16 that are integrally engaged to the exterior side 17 of gasket member second portion 14. The gasket member first portion 12 cooperates with a segment 24 of the gasket member second portion 14 to define a closed first perimeter 22, which encompasses a portion of said closed second parameter 23 when the single piece gasket 10 is in a relaxed state as shown in FIGS. 1 and 1A. A first node portion 20 is defined by the intersection of said first end 15 of gasket member first portion 12 and gasket member second portion 14, and a second node portion 21 is defined by the intersection of the second end 16 of gasket member first portion 12 and gasket member second portion 14.

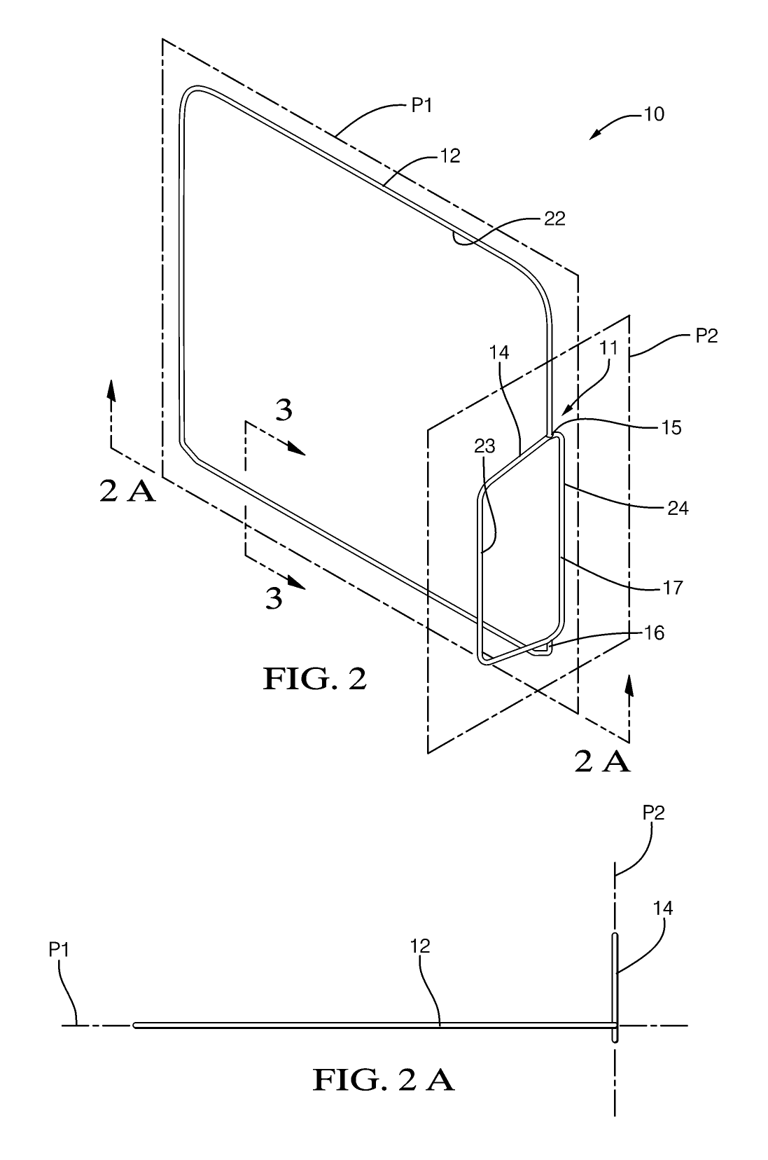

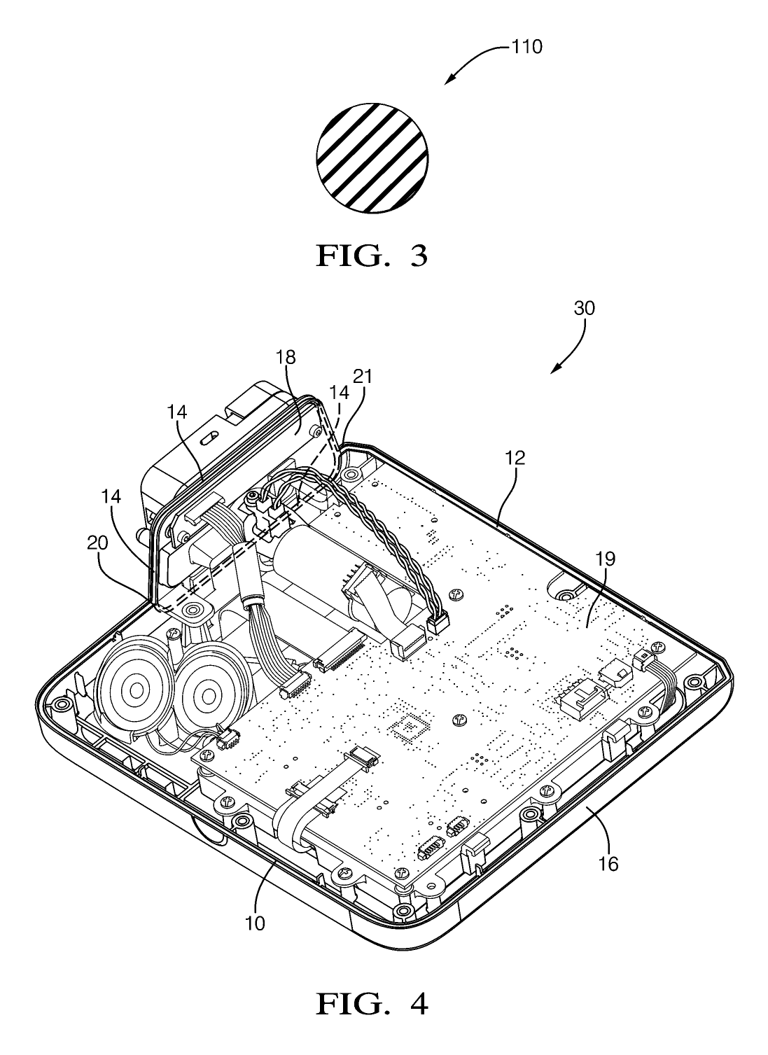

Shown in FIG. 3, the gasket member's first 12 and second portions 14 may each have a substantially circular cross-section at the node portions 20, 21. The substantially circular cross-section allows one of the member portions 12, 14 to rotate relative to the other member portion 12, 14 so that the closed first perimeter 22 extends along a first plane P1 that intersects a second plane P2 on which the closed second perimeter 23 extends when the gasket 10 is in a flexed state, as shown in FIGS. 2 and 2A. However, shown in FIG. 4, the node portions 20, 21 of the one piece gasket 10 that joins the gasket member first and second portions 12, 14, albeit rotated, is still able to be further compressed between mating surfaces of the housing 16 and a cover (not shown) of the housing 16 so as to seal the mating surfaces.

The one piece gasket 10 as shown in FIGS. 1-4 may be made of silicone, or other similar materials that are capable of compression when placed between other components. Other similar materials may include, but are not limited to rubber, neoprene, other polymeric materials, or the like, or combinations thereof. The first and second portions 12, 14 of the one piece gasket 10 as shown in FIGS. 1-4 may also have diameters that are substantially the same. Moreover, as shown in FIG. 3, the gasket member first portion 12 cross-section and the gasket member second portion 14 cross-section have substantially the same cross-sectional area. It is also to be understood that, as a non-limiting example, the one piece gasket 10 as shown in FIGS. 1-4 may have a gasket member first portion 12 cross-sectional diameter and a gasket member second portion 14 cross-sectional diameter in the range of about 1.0 mm to about 3.0 mm.

Referring specifically to FIG. 1A, the one piece gasket 10 is shown in a relaxed state, in which the gasket member first and second portions 12, 14 extends along a common plane P1. The one piece gasket 10 may be formed using an injection molding process or by any other means known in the art. Shown in FIG. 2, the gasket 10 is in a flexed or rotated state in which the gasket member first portion 12 in a first plane P1 and the gasket member second portion 14 in a second plane P2 that intersects the first plane P1. Referring now to FIG. 3, it is to be understood that the cross-section of the first 12 and gasket member second portions 14 may be substantially circular to allow minimal uncompressed deformation to occur to the gasket 10 as the gasket member first portion 12 is rotated with respect to the gasket member second portion 14. It is also to be understood that the uncompressed gasket 10 is capable of being further compressed in substantially all areas of the gasket 10 when the gasket member first portion 12 is rotated into a plane that intersects the plane of the gasket member second portion 14.

With reference now to FIG. 4, an embodiment of the one piece gasket 10 is shown mounted on two components 16, 18 (with a cover to be placed upon the one piece gasket 10 to compress and seal the system). As shown in FIG. 4, the gasket member first portion 12 seals the first component 16 relative to the cover (not shown), and the gasket member second portion 14 is integral to the gasket member first portion 12, but is intended to seal the second component 18 with respect to the first component 16 and cover (not shown).

Although a preferred embodiment of the present invention have been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

What is claimed is:

1. A single piece gasket, comprising:
a gasket member first portion being operatively configured to seal at least two components; and
a gasket member second portion formed integrally with the first member, the gasket member second and first portions each having a substantially circular cross-section.

2. The single piece gasket as defined in claim 1 wherein the single piece gasket is made of silicone.

3. The single piece gasket as defined in claim 1 wherein a diameter of the gasket member first portion cross-section is substantially the same as a diameter of the gasket member second portion cross-section.

4. The single piece gasket as defined in claim 3 wherein the diameter of each of the gasket member first portion cross-section and the gasket member second portion cross-section ranges from about 1.0 mm to about 3.0 mm.

5. The single piece gasket as defined in claim 1 wherein the first and gasket member second portions are configured in a single plane in a relaxed state, and wherein the gasket member first and second portions are configured to seal the at least two components in two non-parallel intersecting planes in a flexed state.

6. A single piece gasket, comprising:
a single continuous gasket member including a gasket member first portion having a first end and a second end, and a gasket member second portion,
wherein said gasket member second portion defines a closed second perimeter having an external side, and said first and second ends of said gasket member first portion is integrally engaged with said external side of said gasket member second portion, thereby defining a closed first perimeter.

7. The single piece gasket of claim 6, wherein said closed first perimeter includes a segment of said gasket second portion.

8. The single piece gasket of claim 7, further comprising a first node portion defined by the intersection of said first end and second portion, and a second node portion defined by the intersection of the second end and second portion, wherein said first and second node portion comprises a elastic material.

9. The single piece gasket of claim 8, wherein said a single continuous gasket member includes a substantially circular cross-section.

10. The single piece gasket of claim 9 further comprises silicone.
